(19) United States
(12) Patent Application Publication
(10) Pub. No.: US 2025/0353022 A1
(43) Pub. Date: Nov. 20, 2025

(54) PARTICLE FEEDPIPE FOR A CENTRIFUGAL PARTICLE RECEIVER

(71) Applicant: Heliogen Holdings, Inc., Pasadena, CA (US)

(72) Inventors: Andrew Stephen Oles, Baltimore, MD (US); Hossein Shamsaei Gahkani, Long Beach, CA (US)

(21) Appl. No.: 18/669,306

(22) Filed: May 20, 2024

(51) Int. Cl. B04B 11/04; F24S 23/30

(52) U.S. Cl. CPC B04B 11/04; F24S 23/30

(57) ABSTRACT

A receiver system for a concentrated solar power system can include a receiver and a particle feed system. The receiver can include a rotating drum and a solar aperture. The particle feed system can include a hopper and a feedpipe. The feedpipe can include an outlet portion and an exit opening. The outlet portion of the feedpipe can be disposed within the rotating drum at a clocking angle between 116 degrees and 150 degrees, a radial angle of less than 10 degrees, and an axial angle of less than 10 degrees. The feedpipe can include one or more cross-sectional reductions to generally maintain a pipe cross-sectional area that is three times the particle flow cross-sectional area. In some embodiments, the particle feed system can include a plurality of feedpipes. The plurality of feedpipes can be aligned at an inclination corresponding to the inclination of the rotating drum.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to a particle receiver system for use, for example, in a concentrated solar power (CSP) system, and more particularly to a particle feed system for feeding particles into a particle receiver.

### Description of the Related Art

Conventional solar energy systems utilize solar panels to convert sunlight into electricity. However, conventional solar energy systems have various drawbacks that make them inefficient and ineffective for capturing energy from the sun and using it for large energy intensive industries. As an alternative to solar panel based solar energy systems, concentrated solar power (CSP) systems have been developed for applications in various energy intensive industrial processes. Many of these CSP systems rely on particles as a heat transfer medium for converting solar energy into thermal energy. In such CSP systems, a centrifugal particle receiver is commonly utilized to heat the particles with concentrated sunlight. However, existing particle feed systems work well at smaller scales, but are too expensive and complex to scale up for larger, commercial centrifugal particle receivers. Further, these feed systems are prone to particle losses due to many particles bouncing around the receiver and fleeing out of the receiver's aperture. Thus, existing CSP systems scale poorly and experience significant particle losses that contribute to energy and economic inefficiencies.

### SUMMARY

The systems, methods, and devices described herein have innovative aspects, no single one of which is indispensable or solely responsible for their desirable attributes. Without limiting the scope of the claims, some of the advantageous features will now be summarized.

The present disclosure provides, among other things, a particle feed system for accelerating particles into a particle receiver. The disclosed particle feed system provides advantages for concentrated solar power systems. Specifically, the disclosed particle feed system can reduce the particle loss rate, thereby improving the energy efficiency and cost effectiveness of the concentrated solar power system. As described herein, the particle loss rate can be reduced by optimizing the particle exit velocity, feedpipe clocking angle, feedpipe radial angle, feedpipe axial angle, feedpipe cross-sectional area, and/or quantity of feedpipes.

In certain aspects, the present disclosure provides, among other things, a particle feed system for feeding particles into a rotating drum of a receiver The particle feed system comprises a feedpipe comprising an outlet portion having an exit opening, wherein the outlet portion is positioned within the rotating drum such that the exit opening is disposed at a clocking angle between about 116 degrees and about 150 degrees.

In certain aspects, the outlet portion is disposed at a radial angle of less than about 10 degrees.

In certain aspects, the outlet portion is disposed at an axial angle of less than about 10 degrees.

In certain aspects, the rotating drum rotates at a rotating drum velocity, wherein the particles leave the exit opening with an exit velocity between about 80% and about 100% of the rotating drum velocity.

In other aspects, the present disclosure provides a receiver system comprising a receiver comprising a rotating drum, wherein the receiver is titled at an inclination angle with respect to a horizontal direction, and a plurality of feedpipes extending into the rotating drum, each of the plurality of feedpipes comprising an outlet portion, wherein the outlet portions are aligned at substantially a same inclination angle as the inclination angle of the receiver.

In certain aspects, the inclination angle is about 45 degrees.

In certain aspects, the plurality of feedpipes includes at least three feedpipes.

In certain aspects, each outlet portion includes an exit opening, wherein each of the outlet portions are positioned within the rotating drum such that the exit openings are disposed at a clocking angle between about 116 degrees and about 150 degrees.

In certain aspects, each of the outlet portions are disposed at a radial angle of less than about 10 degrees.

In certain aspects, each of the outlet portions are disposed at an axial angle of less than about 10 degrees.

In certain aspects, the rotating drum rotates at a rotating drum velocity, wherein particles leave the outlet portions with an exit velocity between about 80% and about 100% of the rotating drum velocity.

In other aspects, the present disclosure provides a feedpipe for accelerating particles into a receiver. The feedpipe comprises a first portion oriented substantially vertically, wherein an acute angle is formed between the first portion and a vertical axis, a second portion coupled to the first portion, wherein the second portion is angled with respect to the first portion to form an obtuse angle between the first portion and the second portion, a third portion coupled to the second portion, wherein the third portion is substantially aligned with the second portion, a fourth portion coupled to the third portion, wherein the fourth portion is angled with respect to the third portion to form an obtuse angle between the third portion and the fourth portion, a fifth portion coupled to the fourth portion, wherein the fifth portion is angled with respect to the fourth portion to form a substantially a 90-degree angle between the fourth portion and the fifth portion, and an exit opening formed on the fifth portion.

In certain aspects, the first portion and the second portion have a first inner diameter, wherein the third portion, the fourth portion, and the fifth portion have a second inner diameter, and wherein the first inner diameter is larger than the second inner diameter.

In certain aspects, between the first portion and the fifth portion, the feedpipe has a cross-sectional area that is maintained between about three times a particle flow cross-sectional area and five times the particle flow cross-sectional area.

In certain aspects, the first portion has a cross-sectional area that is about three times a particle flow cross-sectional area, and wherein the cross-sectional area is reduced at a point along the feedpipe at which the cross-sectional area exceeds about five times the particle flow cross-sectional area.

In certain aspects, the feedpipe further comprises an eccentric reducer disposed between the second portion and the third portion.

In certain aspects, the eccentric reducer has an outlet tangent disposed at a bottom of a particle flow cross-section.

### BRIEF DESCRIPTION OF THE DRAWINGS

Non-limiting features of some embodiments of the inventions are set forth with particularity in the claims that follow. The following drawings are for illustrative purposes only and show non-limiting embodiments. Features from different figures may be combined in several embodiments. It should be understood that the figures are not necessarily drawn to scale. Distances, angles, etc. are merely illustrative and do not necessarily bear an exact relationship to actual dimensions and layout of the devices illustrated.

FIG. 1 depicts a schematic view of a concentration solar power system.

FIG. 2 depicts a schematic view of a receiver system that can be used in the concentrated solar power system of FIG. 1.

FIG. 3A depicts a front cross-sectional view of the receiver system of FIG. 2.

FIG. 3B depicts a top cross-sectional view of the receiver system of FIG. 2.

FIG. 4 depicts a particle flow path within a single feedpipe.

FIG. 5 depicts a particle feed system of the receiver system of FIG. 2.

FIG. 6A depicts a transverse cross-sectional view of a feedpipe at a point of cross-sectional reduction.

FIG. 6B depicts a partial longitudinal cross-sectional view of the feedpipe of FIG. 6A.

FIG. 7 depicts particle flow paths within a plurality of feedpipes.

FIG. 8A depicts a schematic view of a particle flow cross-section at the exit opening of a single feedpipe.

FIG. 8B depicts a schematic view of particle flow cross-sections at the exit openings of a plurality of feedpipes.

### DETAILED DESCRIPTION

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein. Each and every feature described herein, and each and every combination of two or more of such features, is included within the scope of the present invention provided that the features included in such a combination are not mutually inconsistent.

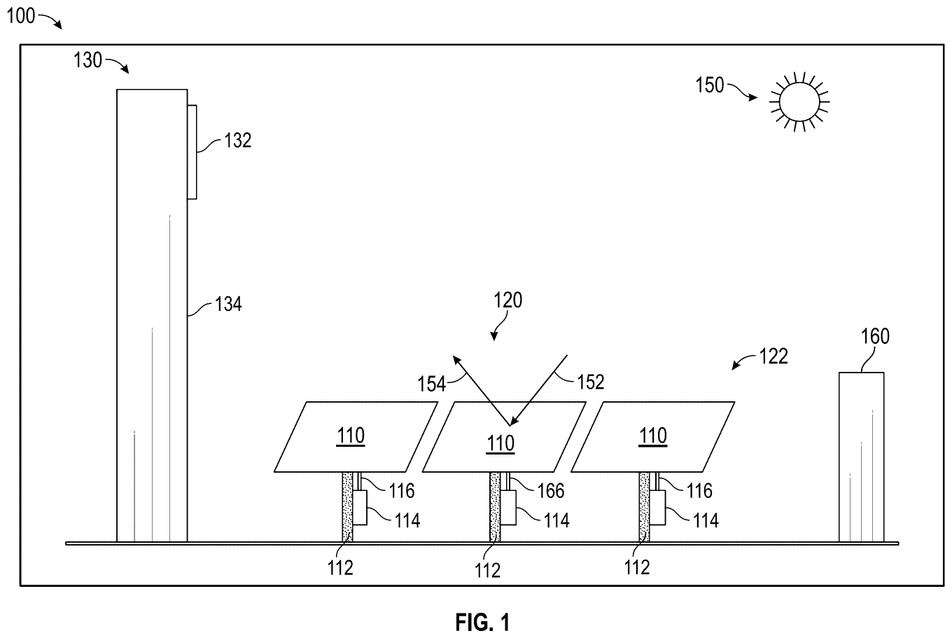

FIGS. 1-8B depict various aspects of a concentrated solar power (CSP) system 100. FIG. 1 depicts a schematic view of an example CSP System 100. The CSP System 100 can include a receiving unit 130, a heliostat array 120, and a power controller 160. The receiving unit 130 can include a receiver system 132 positioned at the top of a tower 134. The heliostat array 120 can include one or more heliostats 122. The heliostats 122 can be supported on shafts or stanchions 112 disposed on or affixed to the ground and/or other heliostats 122. Each heliostat 122 can include a tracking controller 114, an actuator 116, and a mirror 110. The mirrors 110 can receive incoming sunlight 152 from the sun 150 and direct reflected sunlight 154 to the receiver system 132. The tracking controllers 114 can determine the proper orientation of the mirrors 110 throughout the day to maximize the amount of reflected sunlight 154. The power controller 160 can control the heliostat field (e.g., control the orientation of the heliostats) to direct the reflected sunlight 154 to the receiver system 132 throughout the day. The power controller 160 can provide power to each of the tracking controllers 114 and/or actuators 116 that aim the associated mirror 110.

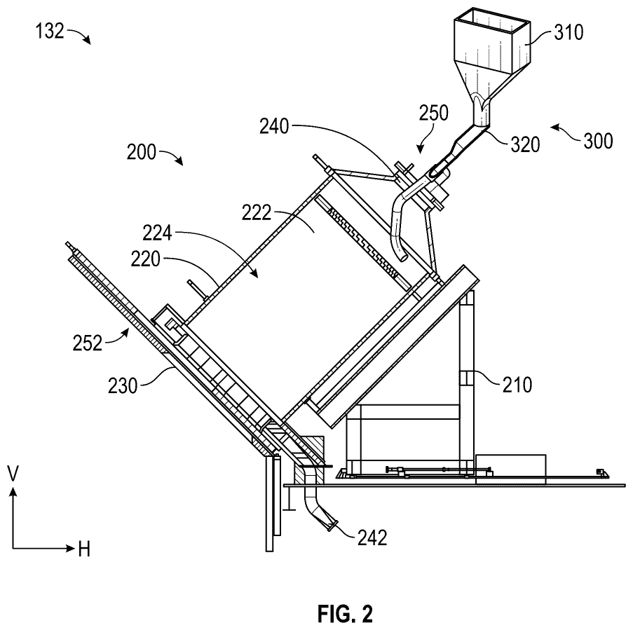

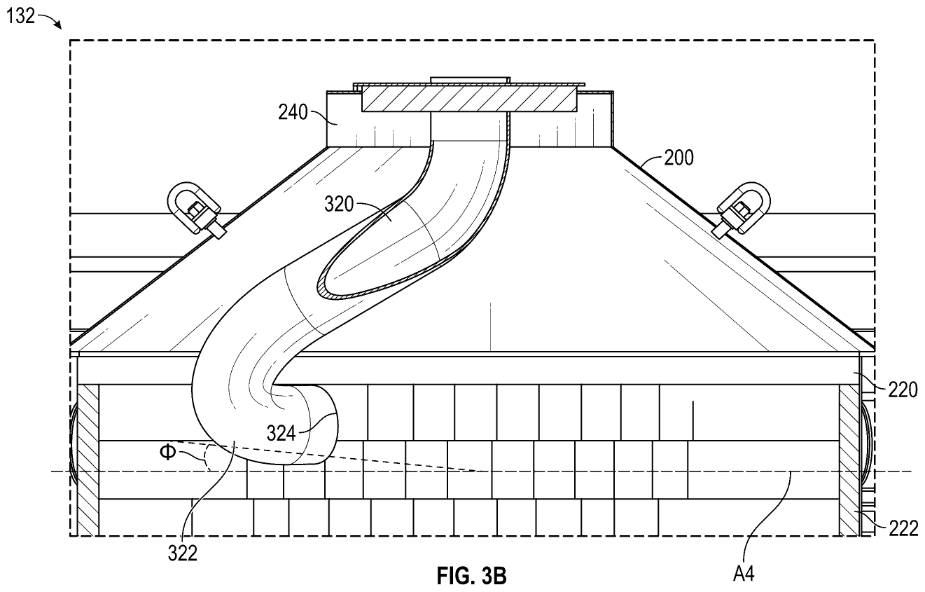

FIG. 2 depicts a schematic view of a receiver system 132 that can be used in the CSP System 100 shown in FIG. 1. The receiver system 132 can be located at an elevated position (e.g., on a roof of a building or on top of a tower 134). The receiver system 132 can be exposed to sunlight (e.g., reflected sunlight 154) directed from the mirrors 110 positioned below the receiver system 132. The receiver system 132 can utilize the reflected sunlight 154 to heat particles 270 (see FIG. 4) conveyed through the receiver system 132. In some embodiments, the receiver system 132 can heat the particles 270 to about 1100° C. In some embodiments, the particles 270 can be made of ceramic materials, inorganic materials, or other materials (e.g., sand, coated sand, bauxite, silica, alumina, iron, etc.). In some embodiments, the particles 270 can be substantially ball-shaped. In some embodiments, the particles 270 can have a size (e.g., diameter) between about 10 μm to about 1000 μm, or any range contained therein (e.g., 10-50 μm, 40-50 μm, 200-400 μm, 10-500 μm, etc.). In some embodiments, the particles 270 can be fluidized (e.g., caused to flow like a fluid) with air, where an airflow stream carries particles 270 to the receiver 200 as the particles 270 travel through the receiver system 132. After being heated, the particles 270 can be transferred out of the receiver system 132 to a thermal energy storage. The heated particles 270 can be used for one or more industrial processes (e.g., generate electricity, generate steam, facilitate calcination, facilitate a chemical process, etc.).

Referring to FIG. 2, the receiver system 132 can include a receiver 200 (e.g., centrifugal particle receiver) and a particle feed system 300. The receiver 200 can facilitate the heating of the particles 270 with reflected sunlight 154. In the illustrated implementation, the receiver 200 is a centrifugal receiver. The receiver 200 can include a frame 210, a rotating drum 220, a particle inlet 240, a particle outlet 242, and a solar aperture 230. A plurality of particles 270 can enter the receiver 200 via the particle inlet 240. The particles 270 can be deposited into the rotating drum 220 by the particle feed system 300. The rotating drum 220 can receive solar flux (e.g., reflected sunlight 154) directed through the solar aperture 230 that heats the particles 270 as the rotating drum 220 is rotated (e.g., as the particles 270 are rotated). After being heated, the particles 270 can exit the receiver 200 via the particle outlet 242.

As shown in FIG. 2 the receiver 200 can be supported by a frame 210. The frame 210 can function as a support structure upon which other components of the receiver 200 can be attached. The frame 210 can support the rotating drum 220. The rotating drum 220 functions to house and rotate particles 270 as they are heated by reflected sunlight 154. The rotating drum 220 can be rotatably coupled to the frame 210. The rotating drum 220 can rotate with respect to the frame 210 while the frame 210 remains stationary. In some embodiments, the rotating drum 220 can rotate at any velocity between about 5 m/s and about 10 m/s. In other embodiments, the rotating drum 220 can rotate below 5 m/s or above 10 m/s. In some embodiments, the rotating drum 220 can rotate at any speed between about 65 rpm and about 70 rpm. As shown in FIGS. 1-8B, the rotating drum 220 can rotate in the counterclockwise direction. In other embodiments, the rotating drum 220 can rotate in the clockwise direction. The rotating drum 220 can be substantially cylindrical. The rotating drum 220 can include an absorber chamber 224 and an inliner 222. The rotating drum 220 can include a hollow interior defining the absorber chamber 224. The absorber chamber 224 can house the particles 270 as they are heated by reflected sunlight 154. The inliner 222 can be disposed on the inner surfaces of the rotating drum 220. The inliner 222 can define an outer boundary of the absorber chamber 224. In some embodiments, the inliner 222 can be formed from a plurality of tiles. In some embodiments, the inliner 222 can be formed by a coating disposed on the inner surface of the rotating drum 220. The inliner 222 can cover all or a significant portion of the inner surface of the rotating drum 220. Particles 270 can be deposited onto the inliner 222 to form a particle film on the inliner 222.

As shown in FIG. 2, the receiver 200 can extend from a first end 250 to an opposing second end 252. The particle inlet 240 can be disposed at or proximate the first end 250 of the receiver 200. The particle inlet 240 can be an opening, port, or the like. The particle inlet 240 can interface with the particle feed system 300 to enable particles 270 to be fed into the receiver 200. The particle outlet 242 can be disposed at or proximate the second end 252 of the receiver 200. The particle outlet 242 can be a collection ring, tube, port, or other structure for receiving and/or collecting particles 270. The particles 270 can exit out of the receiver 200 through the particle outlet 242. The solar aperture 230 can be disposed at the second end 252 of the receiver 200. The solar aperture 230 permits reflected sunlight 154 to enter the receiver 200. Reflected sunlight 154 can be directed through the solar aperture 230 into the absorbing chamber and onto inliner 222. The solar aperture 230 can be a lens, window, opening, or the like. All or substantially all surfaces of the inliner 222 can be exposed to sunlight.

As shown in FIG. 2, the receiver 200 can be tilted at an inclination angle with respect to the horizontal direction H. In some embodiments, the receiver 200 can be tilted at about 45 degrees from the horizontal direction H. Specifically, the receiver 200 can be tilted such that the particle inlet 240 is disposed above (e.g., vertically spaced from) the solar aperture 230. Particles 270 can be deposited onto the inliner 222 proximal to the first end 250 of the receiver 200. Due to the tilt of the receiver 200, gravitational pull causes the particles 270 to move from the first end 250 to the second end 252 of the receiver 200. The reflected sunlight 154 directed through the solar aperture 230 irradiates the particles 270 as they move from the first end 250 to the second end 252, causing the particles 270 to heat up. Downward motion of the particles 270 can be at least partially counteracted by centrifugal forces caused by rotational motion of the rotating drum 220. Centrifugal forces imparted onto the particles 270 by rotation of the rotating drum 220 can hold the particles 270 against the inliner 222. The rotational speed of the rotating drum 220 can be adjusted to increase or decrease the centrifugal forces imparted onto the particles 270. Accordingly, the rotational speed of the rotating drum 220 can be varied to control the amount of time the particles 270 are exposed to sunlight as they travel from the first end 250 to the second end 252 of the receiver 200. Controlling the exposure time enables control of the particle temperature. After moving from the first end 250 to the second end 252, the particles 270 can exit from or be collected at the particle outlet 242.

The particle feed system 300 can function to accelerate and feed particles 270 into the receiver 200. As shown in FIG. 2, the particle feed system 300 can include a hopper 310 and one or more feedpipes 320. The particle feed system 300 can be disposed at least partially above (e.g., vertically spaced from) the receiver 200 such that the force of gravity accelerates particles 270 downwards and into the receiver 200. The hopper 310 can function as a storage chamber for holding particles 270 before they are fed into the receiver 200. The hopper 310 can be a container, chamber, receptacle, or other structure capable of holding a volume of particles 270. The hopper 310 can be controllable to permit or stop the flow of particles 270 out of the hopper 310 and into the one or more feedpipes 320. The hopper 310 can be controllable to vary the flow rate of particles 270 out of the hopper 310.

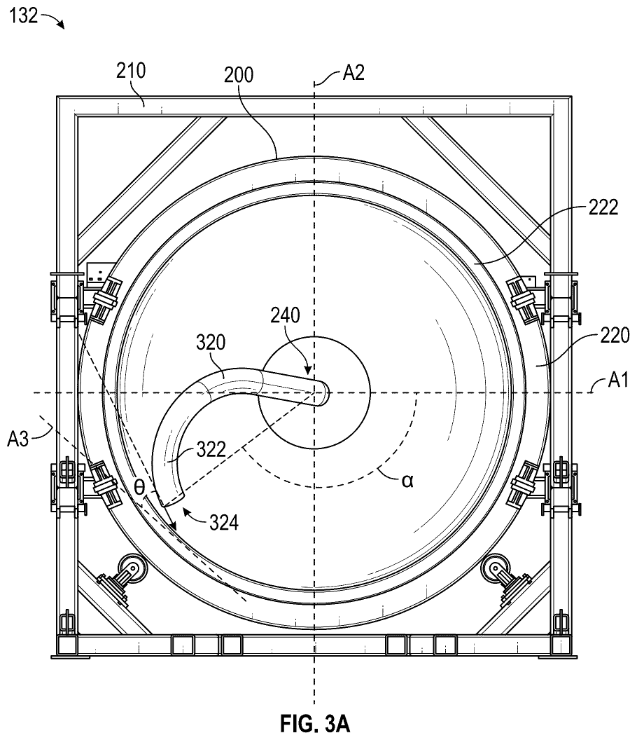

The one or more feedpipes 320 can transfer particles 270 from the hopper 310 into the receiver 200. The feedpipe 320 can be a tube, chute, pipe, channel, vent, or any other structure capable of conveying particle or fluids. The feedpipe 320 can accelerate particles 270 from rest in the hopper 310 and deposit them onto the inliner 222 of the receiver 200. Particles 270 can be conveyed through the feedpipe 320 by gravitational pull. The feedpipe 320 can be coupled to or extend into the particle inlet 240 of the receiver 200. The feedpipe 320 can include an outlet portion 322 (see FIG. 3A) disposed at one end of the feedpipe 320. The outlet portion 322 can be a portion of the feedpipe 320 that controls the flow direction of particles 270 exiting from the feedpipe 320. The outlet portion 322 can be disposed distal to the hopper 310. The outlet portion 322 can have an exit opening 324 through which the particles 270 exit the feedpipe 320. The exit opening 324 can be disposed at a distal end of the feedpipe 320 (e.g., distal to the hopper 310). Various properties of the feedpipe 320 can be adjusted to control the speed and direction of the particles 270 out of the feedpipe 320. As discussed below, any one or more of the curvature, clocking angle α, radial angle θ, axial angle φ, cross-sectional area, and quantity of the feedpipes 320 can be arranged to control the resulting flow of particles 270 out of the one or more feedpipes 320. Optimizing the positioning, speed, and direction of the particle flow into the receiver 200 can enable the particles 270 to settle onto the drum in a stable film, reduce the particle loss rate, and improve overall efficiency of the CSP System 100. In some embodiments, feedpipes 320 incorporating one or more of the improvements discussed below can reduce the particle loss rate from about 400,000 ppm down to less than about 30 ppm.

FIG. 3A depicts a front cross-sectional view of a receiver system 132 (e.g., viewing toward the first end 250). As shown in FIG. 3A, the feedpipe 320 can extend into the rotating drum 220 through the particle inlet 240 of the receiver 200. The outlet portion 322 can be disposed proximal to the inliner 222 such that the gap between the outlet portion 322 and the inliner 222 is minimized. Additionally, the outlet portion 322 can be disposed at or proximate the first end 250 of the receiver 200 such that particles 270 are deposited onto the inliner 222 at or proximate the first end 250. As shown in FIG. 3A, the outlet portion 322 can be offset from the center of the rotating drum 220 by a clocking angle α. With respect to the frame of reference shown in FIG. 3A, the clocking angle α can be defined by the clockwise angle formed between the horizontal midline axis A1 of the rotating drum 220 and the position of the exit opening 324 of the feedpipe 320. The clocking angle α of the feedpipe 320 can be selected to minimize particle losses as the particles 270 are deposited onto the inliner 222 of the rotating drum 220. In some embodiments, the clocking angle α can be about 116 degrees. In some embodiments, the clocking angle α can be any angle between about 150 degrees and about 116 degrees. In FIG. 3A, the rotating drum 220 rotates in the counterclockwise direction and the exit opening 324 is offset to the left side of the rotating drum 220 (e.g., to the left of the vertical midline axis A2). In other embodiments with a rotating drum 220 that rotates in the clockwise direction, the exit opening 324 can be offset to the right side of the rotating drum 220 (e.g., to the right of the vertical midline axis A2) according to a mirrored orientation to what is shown in FIG. 3A (e.g., clocking angle α between about 30 degrees and about 64 degrees relative to horizontal midline axis A1).

The feedpipe 320 can be angled to control the direction of particle flow out of the exit opening 324. Particle loss can be minimized by minimizing axial velocity and radial velocity of the particles 270. The radial velocity can be minimized by positioning the outlet portion 322 of the feedpipe 320 as close to tangent with the rotating drum 220 as possible. As shown in FIG. 3A, the outlet portion 322 of the feedpipe 320 can be offset from a tangent line A3 of the rotating drum 220 by radial angle θ. The tangent line A3 can be tangent to the rotating drum 220 at the point at which particles 270 impact the inliner 222. In some embodiments, the radial angle θ can be equal to or less than about 10 degrees (e.g., 10 degrees, 9 degrees, 8 degrees, 7 degrees, 6 degrees, 5 degrees, etc.). As the particles 270 exit from the feedpipe 320, a downstream acceleration (i.e., acceleration towards the second end 252 of the receiver 200) is imparted on the particles 270 because of gravitational pull. To counteract this downward axial acceleration, the outlet portion 322 can be angled towards the first end 250 of the receiver 200 to impart a small up-stream axial velocity on the particle flow. However, doing so removes a significant amount of momentum from the particle stream and reduces the tangential velocity. As a result, in some embodiments, it can be preferable for the particle flow to exit from the feedpipe 320 with a small downward axial velocity. A shown in FIG. 3B, with respect to the transverse axis A4, the outlet portion 322 of the feedpipe 320 can be angled towards the second end 252 of the receiver 200 across the axial direction by axial angle φ. In some embodiments, the axial angle φ can be about 5 degrees. In some embodiments, the axial angle φ can be any angle between about 0 degrees to about 10 degrees. In some embodiments, the axial angle φ can be between about 5 degrees and about 8 degrees. While angling the outlet portion 322 by a non-zero axial angle φ can increase the axial spread of the particles 270 as they enter the rotating drum 220, it can help inhibit (e.g., prevent) momentum loss in the tangential direction.

In some embodiments, the exit velocity of the particles 270 out of the feedpipe 320 can be controlled at least in part by the shape of the feedpipe 320 and/or the height of the hopper 310. Matching the exit velocity (both speed and direction components) of the particles 270 to the velocity of the rotating drum 220 can reduce particle losses. Particle loss can be minimized by feeding the particles 270 onto the rotating drum 220 with a tangential speed that approximates the tangential speed of the rotating drum 220. In some embodiments, the exit velocity of the particles 270 onto the rotating drum 220 can be about 80% of the rotating drum velocity. In some embodiments, the exit velocity of the particles 270 onto the rotating drum 220 can be any velocity between about 80% and about 100% of the rotating drum velocity. In some embodiments, increasing the particle exit velocity from 60% to at least 80% of the of the rotating drum velocity can reduce particle losses by about 25%. Improving the velocity match between the particle exit velocity and rotating drum 220 velocity can also reduce the wear rate of the inliner 222. The particle exit velocity can be increased by increasing the elevation of the hopper 310 with respect to the rotating drum 220. Providing a larger vertical distance between the hopper 310 and the rotating drum 220 allows the particles 270 to accelerate (under force of gravity) to a higher velocity. Additionally, the shape and/or curvature of the feedpipe 320 can be altered to increase the particle exit velocity. For instance, portions of the feedpipe 320 can be aligned more vertically and/or bends can be softened to reduce velocity losses.

FIG. 4 depicts a particle flow path within a single feedpipe 320. In order to convey particles 270 from the hopper 310 to the receiver 200, it may be required for the feedpipe 320 to include multiple turns to redirect the particles 270 from a mostly axial direction to a direction tangential to the rotating drum 220. When the flow of particles 270 is redirected (e.g., at a feedpipe bend), the particles 270 can undergo a “crash” situation in which the particles 270 impact a surface of the feedpipe 320 and lose significant velocity. FIG. 4 depicts a particle flow stream experiencing a “crash” situation inside the feedpipe 320. For example, particles 270 initially traveling at approximately 7-8 m/s can be reduced to approximately 0-5 m/s after being redirected by a bend in the feedpipe 320. The occurrence and/or severity of a “crash” situation can be determined by a fundamental relationship between particle speed, feedpipe 320 diameter, and feedpipe 320 radius of curvature. In some embodiments, the dimensions of the feedpipe 320 can be controlled to allow for particle flow through the feedpipe 320 without particle “crash” situations where major velocity losses exceed 40 percent. Additionally, the cross-sectional area of the feedpipe 320 can be controlled to prevent clogging of the pipe caused by wall and internal particle friction.

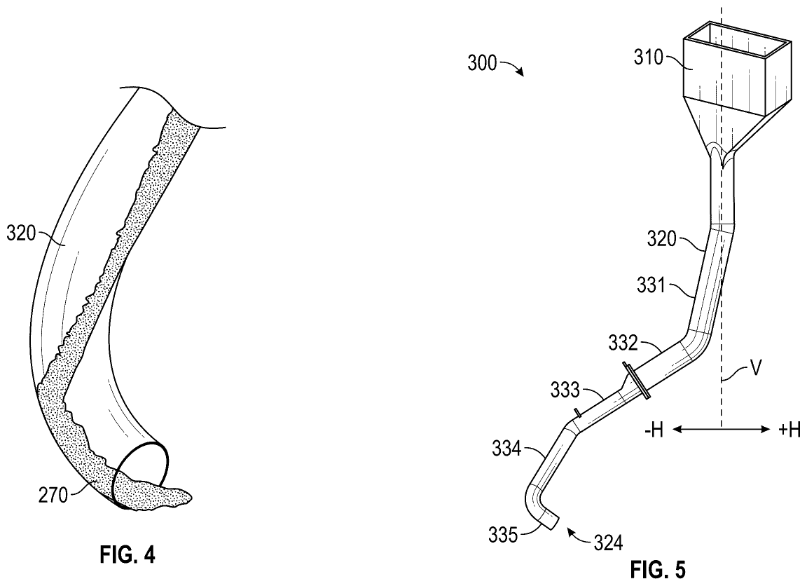

FIG. 5 depicts a particle feed system 300 with a feedpipe 320 having a plurality of bends and a varied cross-sectional area. As shown in FIG. 5, the feedpipe 320 can include a first portion 331, a second portion 332, a third portion 333, a fourth portion 334, a fifth portion 335, and an exit opening 324. However, in other implementations, the feedpipe 320 can have fewer or more pipe portions of varying length, angle and/or diameter between the hopper 310 and the exit opening 324. Particles 270 can flow directionally through the feedpipe 320 from the first portion 331 to the fifth portion 335. The first portion 331 can be coupled to and/or disposed proximal to the hopper 310. In some embodiments, the first portion 331 can be oriented substantially vertically. In some embodiments, the first portion 331 can be angled with respect to the vertical axis V towards the negative horizontal direction −H to form an acute angle between the first portion 331 and the vertical axis. The second portion 332 can be coupled to the first portion 331. The second portion 332 can be angled with respect to the first portion 331 towards the negative horizontal direction −H to form an obtuse angle between the first portion 331 and the second portion 332. The third portion 333 can be coupled to the second portion 332. The third portion 333 can be substantially aligned with the second portion 332 (e.g., extend along substantially the same axis). The third portion 333 can have a smaller cross-sectional area than the second portion 332. In some embodiments, the third portion 333 can extend through (or as near as possible or proximal) to the centerline axis of the rotating drum 220. This positioning can allow for minimal sealing area being required. In some embodiments, the third portion 333 can be oriented between about 30 degrees to about 40 degrees relative to the centerline axis of the rotating drum 220 to accommodate maximum surface velocity. The fourth portion 334 can be coupled to the third portion 333. The fourth portion 334 can be angled with respect to the third portion 333 towards the positive horizontal direction +H to form an obtuse angle between the third portion 333 and the fourth portion 334. The fifth portion 335 can be coupled to the fourth portion 334. The fifth portion 335 can be angled with respect to the fourth portion 334 towards the positive horizontal direction +H to form a substantially a 90-degree angle between the fourth portion 334 and the fifth portion 335. The fifth portion 335 can include the exit opening 324. The feedpipe 320 can have a substantially serpentine shape. In some embodiments, the first portion 331, second portion 332, third portion 333, fourth portion 334, and fifth portion 335 of the feedpipe 320 can be oriented relative to the horizontal with an angle greater than the minimum chute sliding angle for the particle used. The minimum chute sliding angle is a function of the particle material and size and the pipe material that can be found through testing. In some embodiments, if a section of the feedpipe 320 has an angle relative to the horizontal that is lower than the minimum chute sliding angle, particles can build up and adversely impact the flow. The first portion 331 and the second portion 332 can have a first inner diameter. The third portion 333, fourth portion 334, and fifth portion 335 can have a second inner diameter. The first inner diameter can be larger than the second inner diameter. In some embodiments, the first portion 331, second portion 332, third portion 333, fourth portion 334, and fifth portion 335 of the feedpipe 320 can be formed as an integrous unitary structure (e.g., monolithic, seamless pipe structure). In other embodiments, one or more of the first portion 331, second portion 332, third portion 333, fourth portion 334, and fifth portion 335 of feedpipe 320 can be separate components that can be joined together. FIG. 5 depicts a feedpipe 320 for a rotating drum 220 that rotates in the counterclockwise direction. It is to be understood that the feedpipe 320 shape can be mirrored across the vertical axis for use in embodiments with a rotating drum 220 that rotates in the clockwise direction.

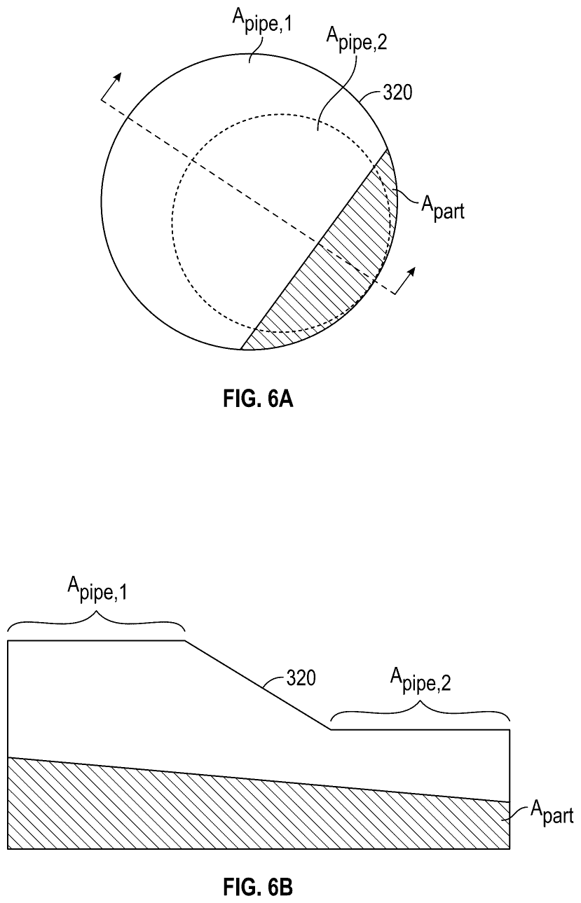

FIGS. 6A-6B depict partial cross-sectional views of the feedpipe 320 at a point of cross-sectional reduction. FIG. 6A depicts a partial transverse cross-sectional view of the feedpipe 320. At a point of cross-section reduction, the feedpipe 320 transitions from a larger inner diameter (depicted as a solid-line circle in FIG. 6A) to a smaller inner diameter (depicted as a dashed-line circle in FIG. 6A). FIG. 6B depicts a partial longitudinal cross-sectional view of the feedpipe 320. FIGS. 6A-6B can correspond to the cross-sectional reduction between the second section and the third section of the feedpipe 320 depicted in FIG. 5. In some embodiments, providing a feedpipe 320 with smaller cross-sections can reduce or prevent occurrences of particle “crash” situations. In some embodiments, the feedpipe 320 can have zero, one, two, or more cross-sectional reductions at any position along the length of the feedpipe 320. In some embodiments, the cross-sectional area of the feedpipe 320 can be continuously reduced or varied along its length. As the particles 270 flow through the feedpipe 320, the particles 270 increase in speed. As the particles 270 speed up, the effective cross-sectional area occupied by the particles 270 decreases. FIG. 6B illustrates this decrease in the particle flow cross-sectional area Aₚₐᵣₜ as the particles 270 flow downstream through the feedpipe 320. The particle flow cross-sectional area Aₚₐᵣₜ can be described by the following formula:

$${A}_{part} = \frac{\dot{m}}{{ρ}_{bulk} u} ,$$

where \dot{m} is the particle mass flow rate, ρ_{bulk} is the density of the particles 270, and u is the particle velocity. Generally, the cross-sectional area of the feedpipe 320 Aₚᵢₚₑ can be varied along its length to correspond to the changing cross-sectional area of the particle flow Aₚₐᵣₜ. In some embodiments, the cross-sectional area of the feedpipe 320 Aₚᵢₚₑ can be dimensioned to be approximately three times the cross-sectional area of the particle flow Aₚₐᵣₜ (e.g., Aₚᵢₚₑ≈3Aₚₐᵣₜ). The initial cross-sectional area of the feedpipe 320 (e.g., at the first portion 331 or proximal to the hopper 310) can be about three times the cross-sectional area of the particle flow. From this initial portion, the cross-sectional area of the feedpipe 320 can remain constant along its length until a point at which the cross-sectional area of the feedpipe 320 becomes about five times greater than the cross-sectional area of the particle flow (e.g., Aₚᵢₚₑ>5Aₚₐᵣₜ). At the point along the feedpipe 320 where this condition is met, the cross-sectional area of the pipe can be reduced back to three times the cross-sectional area of the particle flow. As shown in FIG. 6A-6B, the size of the feedpipe 320 can be reduced from a first cross-sectional area A_{pipe, 1} to a second cross-sectional area A_{pipe, 2}. Accordingly, between the first portion 331 and the fifth portion 335, the cross-sectional area of the feedpipe Aₚᵢₚₑ can be maintained substantially between three times the particle flow cross-sectional area and five times the particle flow cross-sectional area (e.g., 3Aₚₐᵣₜ≤Aₚᵢₚₑ≤5Aₚₐᵣₜ). Cross-sectional reductions of the feedpipe 320 can help to reduce particle velocity losses around curves by keeping the effective radius higher and avoiding particle “crash” situations. In some embodiments, as shown in FIGS. 6A-6B, the reduction in cross-sectional area can be formed by an eccentric reducer. As shown in FIGS. 5-6B, an eccentric reducer can be disposed between the second portion 332 and the third portion 333. As shown in FIG. 6A, the eccentric reducer can have an outlet tangent disposed at the bottom of the particle flow cross-section. Depending on the length of the feedpipe 320 and speed of the particles 270, multiple feedpipe 320 cross-section reductions can be included according to the concepts and ratios outlined above.

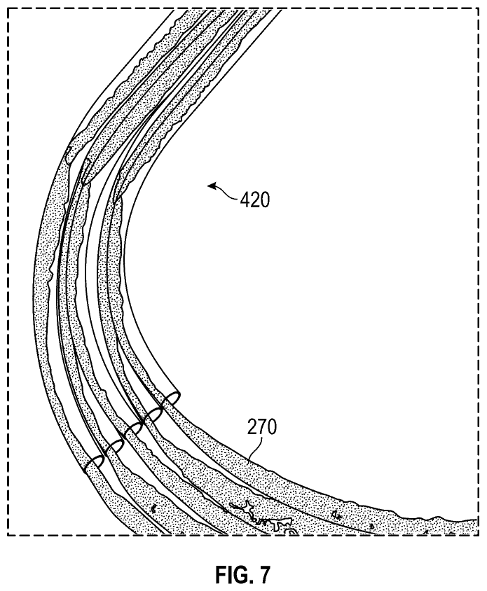

In some embodiments, the particle feed system 300 can include a plurality of feedpipes 420. FIG. 7 depicts example particle flow paths through the plurality of feedpipes 420. As shown in FIG. 7, the particle stream can be divided between the plurality of feedpipes 420. Use of multiple feedpipes 420, as opposed to a single feedpipe 320, can enable more aggressive particle flow bends without resulting in “crash” situations. This in turn can result in higher particle exit velocities, a better velocity match with the inliner 222 velocity at the feed point, and lower particle losses. For example, when the particle exit velocity out of a single feedpipe 320 may be about 3-5 m/s, the particle exit velocity out of a plurality of feedpipes 420 may be about 4-6 m/s, (e.g., about 20 to 30 percent greater). Moreover, as discussed in more detail below, the use of a plurality of feedpipes 420 can reduce the particle drop-off distances between the feedpipes and the inliner 222.

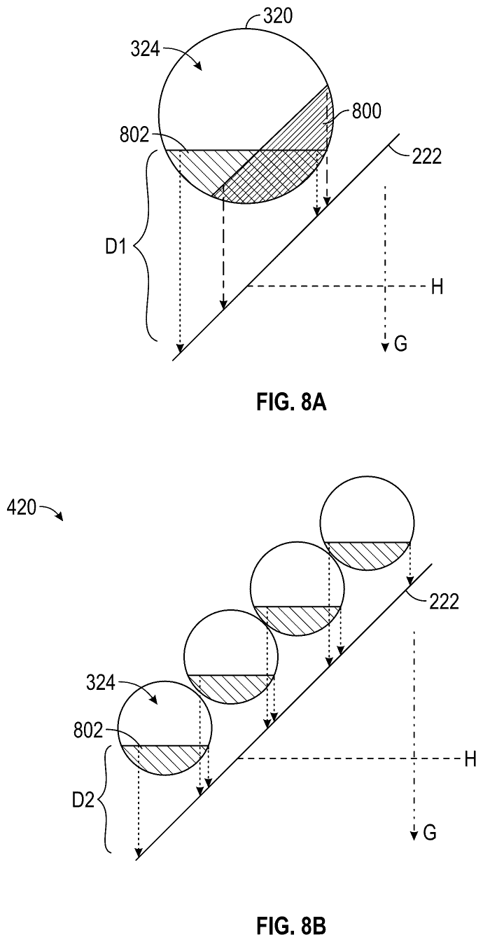

FIG. 8A depicts a schematic view of a particle flow cross-section at the exit opening 324 of a single feedpipe 320. When only a single feedpipe 320 is used, the inner diameter of the feedpipe 320 must be large enough to convey all particles 270. As shown, in FIG. 8A, the inliner 222 can be disposed at an inclination of about 45 degrees corresponding to the tilt angle of the receiver 200. Preferably, the particle stream would exit the feedpipe 320 with the same inclination as the inliner 222 (e.g., 45 degrees) to reduce the drop-off distance of the particles 270. FIG. 8A depicts the preferred particle flow cross-section 800 with an inclination that matches the inliner 222 inclination. However, as shown by the actual particle flow cross-section 802 in FIG. 8A, the downward pull of gravity causes the particle stream to spread out evenly at the bottom portion of the feedpipe 320 along the horizontal direction H. As a result, with reference to FIG. 8A, particles 270 exiting towards the “left” side of the exit opening 324 fall a greater distance before striking the inliner 222 than the particles 270 on the “right” side of the exit opening 324. The larger particle fall distance results in the particles 270 having more axial spread and higher normal velocity when impacting the inliner 222. The higher normal velocity causes a greater number of particles 270 to bounce off the inliner 222 and subsequently fail to settle into a stable film on the inliner 222 before the “upstroke” of the drum rotation. Instead, the bouncing particles 270 remain completely separated from the film and eventually fall out the aperture 230 leading to a higher particle loss rate.

FIG. 8B depicts a schematic view of particle flow cross-sections at the exit openings 324 of a plurality of feedpipes 420. As shown in FIG. 8B, the particle feed system 300 can include four feedpipes 320. In other embodiments, the particle feed system 300 can include two, three, four, five, or any other number of feedpipes 320. As shown in FIG. 8B, the plurality of feedpipes 420 can be disposed adjacent to one another. The plurality of feedpipes 420 can be spatially offset from one another with respect to the horizontal axis H. Specifically, the plurality of feedpipes 420 can be sequentially aligned at an inclination. As shown in FIG. 8B, the plurality of feedpipes 420 can be aligned at an inclination substantially corresponding to the inclination of the inliner 222. For example, the plurality of feedpipes 420 can be aligned at about 45 degrees to match the incliner inclination of about 45 degrees. In other embodiments, the plurality of feedpipes 420 can be aligned at any angle. As shown in FIG. 8B, each one of the plurality of feedpipes 420 can have a smaller inner diameter than the single feedpipe 320 of FIG. 8A. In some embodiments, each of the plurality of feedpipes 420 can have the same inner diameter. In other embodiments, one or more of the plurality of feedpipes 420 can have different inner diameters. As shown in FIG. 8B, the inclined arrangement and smaller inner diameters of the plurality of feedpipes 420 allows the particle streams to exit from the feedpipes 320 at average positions that are much closer to the inliner 222. Compared to the single feedpipe 320 of FIG. 8A, particles 270 exiting towards the “left” side of each of the exit openings 324 of the plurality of feedpipes 420 have a shorter height to fall before striking the inliner 222. As shown in FIGS. 8A-8B, the maximum particle drop-off height D2 of the plurality of feedpipes 420 can be less than the maximum particle drop-off height D1 of the single feedpipe 320. The reduced drop-off distance reduces the particle impact velocity onto the inliner 222, which in turn results in less bouncing and less particle loss. Use of a plurality of feedpipes 420 can provide particle flow cross-sections that more closely approximate the preferred particle flow cross-section 800 depicted in FIG. 8A.

While certain embodiments of the inventions have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations, one or more features from a claimed combination can, in some cases, be excised from the combination, and the combination may be claimed as a sub-combination or variation of a sub-combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects, and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or sub-combinations of these specific features and aspects of embodiments may be made and still fall within the scope of the invention. Accordingly, it should be understood that various features and aspects of the disclosed embodiments can be combined with or substituted for one another in order to form varying modes of the discussed automobile.

1. A particle feed system for feeding particles into a rotating drum of a receiver, the particle feed system comprising:
a feedpipe comprising an outlet portion having an exit opening, wherein the outlet portion is positioned within the rotating drum such that the exit opening is disposed at a clocking angle between about 116 degrees and about 150 degrees, wherein the clocking angle is a clockwise angle formed between a horizontal midline axis of the rotating drum and the exit opening.

2. The particle feed system of claim 1, wherein the outlet portion is disposed at a radial angle of less than about 10 degrees relative to a line tangent to the rotating drum.

3. The particle feed system of claim 1, wherein the outlet portion is disposed at an axial angle of less than about 10 degrees relative to an axis transverse to a central axis of the rotating drum so that the exit opening is angled toward a distal end of the rotating drum.

4. The particle feed system of claim 1, wherein the rotating drum rotates at a rotating drum velocity, wherein the particles leave the exit opening with an exit velocity between about 80% and about 100% of the rotating drum velocity.

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. The particle feed system of claim 1, wherein the clocking angle is about 140 degrees.

19. (canceled)

20. The particle feed system of claim 1, wherein the exit opening is offset to a left side a vertical midline axis of the rotating drum, the rotating drum rotating in a counterclockwise direction.

21. The particle feed system of claim 1, wherein the outlet portion is disposed at a radial angle of between 5 degrees and 10 degrees relative to a line tangent to the rotating drum.

22. The particle feed system of claim 1, wherein the outlet portion is disposed at an axial angle of between about 5 degrees and 8 degrees relative to an axis transverse to a central axis of the rotating drum so that the exit opening is angled toward a distal end of the rotating drum.

23. The particle feed system of claim 1, wherein the rotating drum rotates at a rotating drum velocity, wherein the particles leave the exit opening with an exit velocity of about 80% of the rotating drum velocity.

24. A receiver system comprising:
a receiver comprising a rotating drum, wherein the receiver is tilted at an inclination angle with respect to a horizontal direction; and
a feedpipe comprising an outlet portion having an exit opening, wherein the outlet portion is positioned within the rotating drum such that the exit opening is disposed at a clocking angle between about 116 degrees and about 150 degrees, wherein the clocking angle is a clockwise angle formed between a horizontal midline axis of the rotating drum and the exit opening.

25. The receiver system of claim 24, wherein the outlet portion is disposed at a radial angle of less than about 10 degrees relative to a line tangent to the rotating drum.

26. The receiver system of claim 24, wherein the outlet portion is disposed at an axial angle of less than about 10 degrees relative to an axis transverse to a central axis of the rotating drum so that the exit opening is angled toward a distal end of the rotating drum.

27. The receiver system of claim 24, wherein the rotating drum rotates at a rotating drum velocity, wherein the particles leave the exit opening with an exit velocity between about 80% and about 100% of the rotating drum velocity.

28. The receiver system of claim 24, wherein the clocking angle is about 140 degrees.

29. (canceled)

30. The receiver system of claim 24, wherein the exit opening is offset to a left side a vertical midline axis of the rotating drum, the rotating drum rotating in a counterclockwise direction.

31. The receiver system of claim 24, wherein the outlet portion is disposed at a radial angle of between 5 degrees and 10 degrees relative to a line tangent to the rotating drum.

32. The receiver system of claim 24, wherein the outlet portion is disposed at an axial angle of between about 5 degrees and 8 degrees relative to an axis transverse to a central axis of the rotating drum so that the exit opening is angled toward a distal end of the rotating drum.

33. The receiver system of claim 24, wherein the rotating drum rotates at a rotating drum velocity, wherein the particles leave the exit opening with an exit velocity of about 80% of the rotating drum velocity.
